(19) United States
(12) Patent Application Publication
(10) Pub. No.: US 2024/0219652 A1
(43) Pub. Date: Jul. 4, 2024

(54) PHOTOELECTRIC TRANSCEIVER AND OPTICAL MODULE

(71) Applicant: SHUNYUN TECHNOLOGY (ZHONG SHAN) LIMITED, Zhongshan (CN)

(72) Inventor: JIE HUANG, Zhongshan City (CN)

(21) Appl. No.: 18/107,441

(22) Filed: Feb. 8, 2023

(30) Foreign Application Priority Data
Dec. 28, 2022 (CN) 202211695162.2

(51) Int. Cl. G02B 6/42

(52) U.S. Cl. CPC G02B 6/4206; G02B 6/4246; H04B 10/40

(57) ABSTRACT

A photoelectric transceiver, includes a first substrate, provided with a plurality of holding slots; a plurality of tapered spherical lens fibers, respectively partially accommodated in the plurality of holding slots for receiving optical signals; a second substrate, with a preset distance from the first substrate; and a plurality of lasers, arranged on a side of the second substrate to align the plurality of tapered spherical lens fibers one by one, and configured to directly emit the optical signals to the plurality of tapered spherical lens fibers. In the present disclosure, the optical fiber adopts the tapered end spherical lens optical fiber, and directly corresponds to the laser one by one to directly receive the optical signal sent by the laser, so that the internal optical path transmission does not need to pass through the straight lens and the focusing lens, saving material costs and improving production efficiency.

### FIELD

The subject matter herein generally relates to a technical field of optical communication, in particular to a photoelectric transceiver and an optical module.

### BACKGROUND

Due to the increasing demand for bandwidth, 100G and 400G networks are developing rapidly. 100G optical modules are the main components of 100G networks, and 100 Gbps parallel single mode 4 lanes (PMS4) is commonly used. The 100 Gbps PMS4 standard is formulated by the MSA team. The 100G PSM4 standard is mainly a low-cost solution to realize the interconnection between long-distance data centers. 100G PSM4 optical module is a parallel single mode 4 lanes optical module, which is mainly suitable for the application of 500 meters in the data center. Previously, the internal optical path of the PSM4 photoelectric transceiver module used collimating lens+focusing lens for optical path transmission. This structure requires large space and eight lens coupling (collimating lens coupling 4 times+focusing lens coupling 4 times) process, resulting in low production efficiency of this structure. Since the internal optical transmission requires four collimating lenses and four focusing lenses, the material cost is high.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is an application diagram of a photoelectric transceiver according to an embodiment of the present disclosure.

FIG. 2 is a structure diagram of a photoelectric transceiver according to an embodiment of the present disclosure.

FIG. 3 is an outside view of a lens according to an embodiment of the present disclosure.

FIG. 4 is a side view of the optical transceiver according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

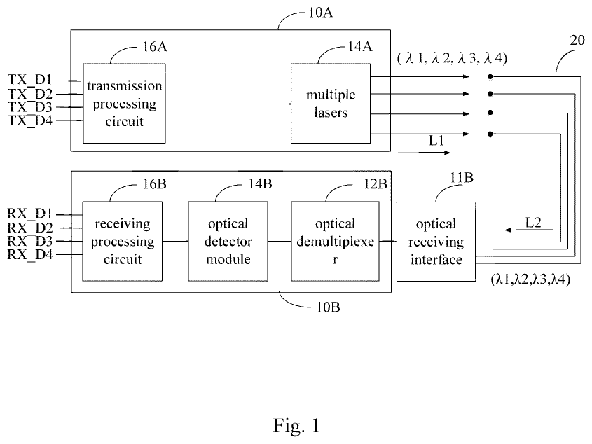

FIG. 1 is an application diagram of an optical fiber array according to an embodiment of the present disclosure. In the embodiment, optical fibers 20 are important coupling components connecting the optical emitting device and the optical receiving device. The optical emitting device includes a transmitter optical subassembly 10A. The transmitter optical subassembly 10A includes a transmission processing circuit 16A and multiple lasers 14A. The multiple lasers 14A and the optical fibers 20 can form a photoelectric transceiver. In the embodiment, the number of the multiple lasers 14A is preferably four, and the number of optical fibers 20 is correspondingly set to four, and the optical signal of the four lasers 14A enters four optical fibers 20 respectively. The optical receiving device includes an optical receiving interface 11B and a receiver optical subassembly 10B. The receiver optical subassembly 10B includes an optical demultiplexer 12B, an optical detector module 14B, and a receiving processing circuit 16B. The photoelectric transceiver is connected to an optical fiber cable through the optical receiving interface 11B. In the embodiment, the optical transmitting interface 11A and optical receiving interface 11B can be ST type, SC type, FC type, LC type, etc.

The dense wavelength division multiplexing (DWDM) technology has characteristics of bandwidth and low loss of single-mode fiber, which uses multiple wavelengths as carriers, allowing each carrier channel to transmit simultaneously in the fiber. In the embodiment, the present disclosure utilizes a dense wavelength division multi task technology to enable the optical module device to use four channels to receive or transmit four different channel wavelengths (λ1, λ2, λ3, λ4), so an optical signal L1 transmitted by the multiple lasers 14A with four wavelengths: λ1, λ2, λ3, λ4, etc., an optical signal L2 received by the optical receiving interface 11B with four wavelengths: λ1, λ2, λ3, λ4, etc. The number of optical detection components of the optical detector 14B and laser components of the multiple lasers 14A also correspond to the number of channels. Although the embodiment takes four channel configurations as an example, other channel configurations (for example, 2, 8, 16, 32, etc.) are also within the scope of the present disclosure.

As shown in FIG. 1, electrical data signals (TX_D1 to TX_D4) received by the transmission processing circuit 16A are output to the multiple lasers 14A after a conversion processing, and the multiple lasers 14A modulates the received electrical data signals into optical signals. In the embodiment, the multiple lasers 14A can include multiple distributed feedback laser (DFB) lasers with diffraction gratings. In other embodiments, other elements that can be used as light sources, such as light emitting diodes (LED), edge emitting laser diodes (EELD), electro-absorption modulated laser (EML) laser diode packages, and vertical cavity surface emitting laser diodes (VCSEL), also known as surface emitting laser diodes, which is an array formed by multiple vertical cavity surface emitting laser diodes and are driven by a driving chip to emit optical signals.

The optical signal L2 is transmitted to the optical demultiplexer 12B via the optical receiving interface 11B. In the embodiment, the optical demultiplexer 12B uses the arrayed waveguide grating (AWG) technology to divide the optical signal L2 into optical signals corresponding to wavelengths of Δ1, λ2, λ3, λ4, etc. The optical detector 14B (in the embodiment, four as an example, but not limited to) detects optical signals and generates corresponding electrical signals. In the embodiment, the optical detector 14B can include a PIN (P-doped-intrinsic-doped-N) diode or an avalanche photodiode (APD). After the electrical signal generated by the optical detector 14B is processed by an amplification circuit (such as a trans impedance amplifier (TIA)) and a conversion circuit of the receiving processing circuit 16B, the electrical data signals transmitted by the optical signal L2 (such as RX_D1 to RX_D4) can be obtained. In other embodiments of the present disclosure, the optical demultiplexer 12B can also convert optical signal L2 into optical signals of different wavelengths by using fiber bragg grating (FBG) and other related technologies.

In the embodiment, the transmitter optical subassembly 10A and the receiver optical subassembly 10B can also include other functional circuit elements, such as a laser driver used to drive the laser module 14A, an automatic power control (APC), a monitor photo diode (MPD) used to monitor a laser power, and other circuit elements necessary for implementing the optical signal transmission function, receiving optical signals and processing, as well as digital signal processing integrated circuits used to process the electrical signals transmitted from the receiver optical subassembly 10B and the electrical signals to be transmitted to the transmitter optical subassembly 10A, which are well known to those skilled in the art, and will not be repeated here for simplified description.

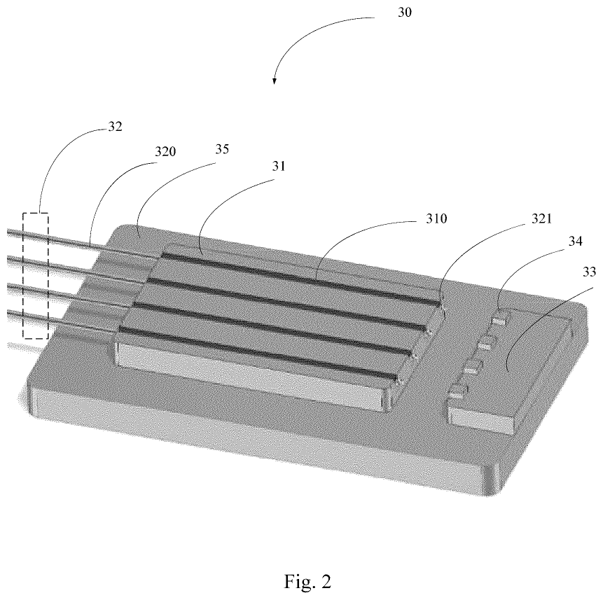

FIG. 2 is a schematic structural diagram of a photoelectric transceiver 30 according to an embodiment of the present disclosure. As shown in FIG. 2, the photoelectric transceiver 30 includes a first substrate 31, a plurality of tapered spherical lens fibers 32, a second substrate 33 and a plurality of lasers 34. The plurality of tapered spherical lens fibers 32 and the plurality of lasers 34 correspond one to one. In the embodiment, the number of the plurality of tapered spherical lens fibers 32 is preferably 4 and the number of the plurality of lasers 34 is preferably 4, so photoelectric transceiver 30 is a parallel single mode 4 lanes (PSM4) photoelectric transceiver, but not limited thereto.

In the embodiment, the first substrate 31 is provided with a plurality of holding slots 310, and the plurality of holding slots 310 can be U-shaped slots or V-shaped slots for accommodating the plurality of tapered spherical lens fibers 32. The plurality of tapered spherical lens fibers 32 are respectively partially accommodated in the plurality of holding slots for receiving optical signals. The tapered spherical lens optical fiber 32 is ground into a tapered shape on an end face of the optical fiber by a precision grinding equipment, and then an optical microsphere lens is processed at the tip by special processing means, so as to achieve the purpose of expanding the numerical aperture of the optical fiber and increasing the light absorption capacity.

Specifically, each tapered spherical lens fiber 32 may include an optical fiber cable 320 and a lens 321. The optical fiber cable 320 is partially accommodated in the corresponding holding slot 310 for transmitting optical signals. A coating layer of the part of the optical fiber cable arranged in the holding slot is removed to reduce the size of the holding slot 310. It can be understood that the size of the holding slot 310 is set according to the diameter of the optical fiber cable 320. The optical fiber cable 320 can be fixed to the holding slot 310 through an adhesive layer. The adhesive layer can include polyimide (PI), polyethylene terephthalate (PET), teflon, liquid crystal polymer (LCP), polyethylene (PE), polypropylene (PP), polystyrene (PS), polyvinyl chloride (PVC), nylon or polyamides, polymethyl methacrylate (PMMA), acrylonitrile-butadiene-styrene, phenolic resin, epoxy, polyester, silicone, polyurethane (PU), polyamide imide (PAI) or a combination thereof, but not limited to this, as long as the materials with adhesion characteristics can be applied to the present disclosure.

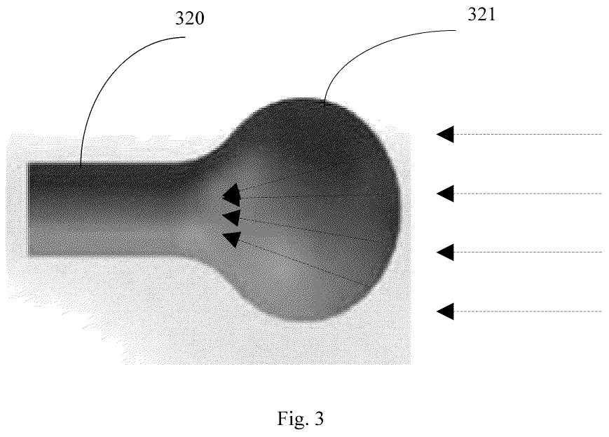

The lens is located at an end of the optical fiber cable 320, and is configured to receive the optical signal. Referring to FIG. 3, FIG. 3 is a schematic diagram of an outside view of the lens 321 according to an embodiment of the present disclosure. As shown in FIG. 3, the lens 321 is in a conical shape and can gather the optical signals emitted from the outside into the optical fiber cable 320 for transmission. The lens 320 can be any one of semicircular lens, conical lens, Fresnel lens, microsphere lens and tapered semicircular lens.

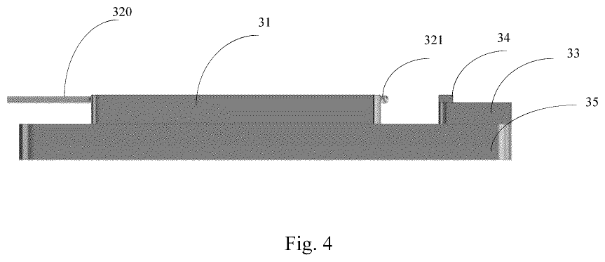

Referring to FIG. 4, FIG. 4 is a side view of the optical transceiver according to an embodiment of the present disclosure. As shown in FIG. 4, part of the optical fiber cable 320 is accommodated in the corresponding holding slot 310. The lens fits an outer edge of the holding slot 310 and corresponds to the laser 34 one by one.

There is a present distance between the first substrate 31 and the second substrate 33. A plurality of lasers 34 are arranged on one side of the second substrate 33, and are aligned with the plurality of tapered spherical lens fibers 32 one by one, for directly transmitting the optical signal to the plurality of tapered spherical lens fibers 32. In order to ensure the best optical reception efficiency, the preset distance between the first substrate 31 and the second substrate 33 is preferably 2.5 mm.

In the embodiment, the photoelectric transceiver 30 further includes a base 35, wherein the first substrate 31 and the second substrate 33 are mounted on the base 35. Specifically, the first substrate 31 and the second substrate 33 can be fixed to the base 35 through the adhesive layer. The adhesive layer can include polyimide (PI), polyethylene terephthalate (PET), teflon, liquid crystal polymer (LCP), polyethylene (PE), polypropylene (PP), polystyrene (PS), polyvinyl chloride (PVC), nylon or polyamides, polymethyl methacrylate (PMMA), acrylonitrile-butadiene-styrene, phenolic resin, epoxy, polyester, silicone, polyurethane (PU), polyamide imide (PAI) or a combination thereof, but not limited to this, as long as the materials with adhesion characteristics can be applied to the present disclosure.

In the embodiment, the photoelectric transceiver 30 can also be equipped with a protective plate (not shown in the figure) on the base 35 and cover a part of the optical fiber cable 320 to protect the optical fiber cable 320.

According to the photoelectric transceiver described in the embodiment of the present disclosure, the optical fiber adopts the tapered end spherical lens optical fiber, and directly corresponds to the laser one by one to directly receive the optical signal sent by the laser, so that the internal optical path transmission does not need to pass through the straight lens and the focusing lens, saving material costs and improving production efficiency.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A photoelectric transceiver, comprising:
a first substrate provided with a plurality of holding slots;
a plurality of tapered spherical lens fibers respectively partially accommodated in the plurality of holding slots for receiving optical signals;
a second substrate with a preset distance from the first substrate; and
a plurality of lasers arranged on a side of the second substrate to align the plurality of tapered spherical lens fibers one by one, and configured to directly emit the optical signals to the plurality of tapered spherical lens fibers.

2. The photoelectric transceiver according to claim 1, wherein the optical signals emitted by the plurality of lasers respectively enter the plurality of tapered end ball lens optical fibers.

3. The photoelectric transceiver according to claim 1, further comprising a base, wherein the first substrate and the second substrate are mounted on the base.

4. The photoelectric transceiver according to claim 1, wherein each tapered spherical lens fiber comprises:
an optical fiber cable partially accommodated in a corresponding holding slot, and configured to transmit the optical signal;
a lens located at an end of the optical fiber cable, and configured to receive the optical signal.

5. The photoelectric transceiver according to claim 4, wherein a coating layer of the part of the optical fiber cable arranged in the holding slot is removed.

6. The photoelectric transceiver according to claim 4, wherein the lens is any one of semicircular lens, conical lens, Fresnel lens, microsphere lens and tapered semicircular lens.

7. The photoelectric transceiver according to claim 4, wherein:
part of the optical fiber cable is accommodated in the corresponding holding slot;
the lens fits an outer edge of the holding slot.

8. The photoelectric transceiver according to claim 1, wherein:
a number of the plurality of tapered spherical lens fibers is 4;
a number of the plurality of lasers is 4;
the photoelectric transceiver is a parallel single mode 4 lanes photoelectric transceiver.

9. The photoelectric transceiver according to claim 1, wherein the preset distance between the first substrate and the second substrate is 2.5 mm.

10. An optical module, comprising a photoelectric transceiver, wherein the photoelectric transceiver comprises:
a first substrate, provided with a plurality of holding slots;
a plurality of tapered spherical lens fibers, respectively partially arranged in the plurality of holding slots for receiving optical signals;
a second substrate, with a preset distance from the first substrate; and
a plurality of lasers, arranged on a side of the second substrate to align the plurality of tapered spherical lens fibers one by one, and configured to directly emit the optical signals to the plurality of tapered spherical lens fibers.

11. The optical module according to claim 10, wherein the optical signals emitted by the plurality of lasers respectively enter the plurality of tapered end ball lens optical fibers.

12. The optical module according to claim 10, wherein the photoelectric transceiver further comprises a base, wherein the first substrate and the second substrate are mounted on the base.

13. The optical module according to claim 10, wherein each tapered spherical lens fiber comprises:
an optical fiber cable, partially accommodated in a corresponding holding slot, and configured to transmit the optical signal;
a lens, located at an end of the optical fiber cable, and configured to receive the optical signal.

14. The optical module according to claim 13, wherein a coating layer of the part of the optical fiber cable arranged in the holding slot is removed.

15. The optical module according to claim 13, wherein the lens is any one of semicircular lens, conical lens, Fresnel lens, microsphere lens and tapered semicircular lens.

16. The optical module according to claim 13, wherein
part of the optical fiber cable is accommodated in the corresponding holding slot;
the lens fits an outer edge of the holding slot.

17. The optical module according to claim 10, wherein:
a number of the plurality of tapered spherical lens fibers is 4;
a number of the plurality of lasers is 4;
the photoelectric transceiver is a parallel single mode 4 lanes photoelectric transceiver.

18. The optical module according to claim 10, wherein the preset distance between the first substrate and the second substrate is 2.5 mm.
